(19) United States
(12) Patent Application Publication
(10) Pub. No.: US 2003/0098205 A1
(43) Pub. Date: May 29, 2003

(54) Aircraft fluid drip pan system

(76) Inventor: Christopher L. Bemis, Glendale, AZ (US)

Correspondence Address: STONEMAN LAW OFFICES, LTD, 3113 NORTH 3RD STREET, PHOENIX, AZ, 85012, US

(21) Appl. No.: 10/307,056

(22) Filed: Nov. 29, 2002

Related U.S. Application Data
(60) Provisional application No. 60/341,100, filed on Nov. 29, 2001.

(51) Int. Cl. F16N 31/00

(52) U.S. Cl. 184/106

(57) ABSTRACT

A system for improved collection and containment of fluids such as oils that commonly drip from an aircraft during service maintenance operations and during normal periods of storage. The system comprises a ground-supported drip pan incorporating a peripheral cutout adapted to accommodate a landing wheel of the aircraft to permit effective positioning under the engine. An embodiment for exterior use utilizing the weight of the aircraft to prevent movement of the system is also disclosed.

### CROSS-REFERENCE TO RELATED APPLICATION

The present application is related to applicant's prior U.S. Provisional Application No. 60/341,100, filed Nov. 29, 2001, entitled “AIRCRAFT OIL DRIP PAN”, the contents of which are herein incorporated by reference and are not admitted to be prior art with respect to the present invention by their mention in this cross-reference section.

### BACKGROUND

This invention relates to providing a system for improved collection and containment of fluids such as oils that commonly drip from an aircraft during service maintenance operations and during normal periods of storage.

Typically, aircraft engines as well as other internal combustion engines employ oil, whether natural or synthetic, and sometimes other fluids for lubrication and cooling. When the aircraft is parked in a hangar or tied down on the tarmac these fluids will commonly leak from the engine compartment, normally in small quantities. Even in small amounts these fluids will collect on the parking pavement. The pavement surface, usually asphalt, absorbs these petroleum drippings and is affected by that absorption to the detriment and degradation of the parking surface and even of the environment.

In addition, part of the pre-flight inspection of aircraft by the crew before departure requires that small quantities of fuel be drained from the tanks and inspected to assure all condensed moisture is removed, and to confirm that the fuel is the proper grade and octane for the engines in the aircraft. In the past this drained fuel has been discarded by being thrown on the pavement. This practice is no longer acceptable in these environmentally conscious times. It is now forbidden by airport management and environmental authorities, and is frequently illegal.

A need has arisen for a means to dispose of or collect these residues safely and conveniently.

Since the engine compartment is normally above the nose wheel of single engine aircraft and commonly adjacent the main landing gear wheels of twin-engine aircraft, drip pans intended for use by automobiles cannot be used, not having an accommodation for the wheel.

### OBJECTS OF THE INVENTION

A primary object and feature of the present invention is to provide a system to hold an accumulation of fluids that drip from an aircraft by the use of a drip pan placed under the engine compartment.

It is a further object and feature of the present invention to provide such a system that provides an effective means to dispose of such accumulations at the convenience of the operator or maintenance crews.

It is another object and feature of the present invention to provide such a system that addresses the need for a place of temporary containment of fuel contaminants.

It is a further object and feature of the present invention to provide such a system that incorporates a cutout for a landing wheel of the aircraft within the reservoir area of such drip pan to permit effective positioning of such a drip pan.

It is another object and feature of the present invention to provide such a system that has a web that fits under the aircraft wheel, thus effectively fixing the pan in place to prevent it being moved by wind, weather, or theft.

It is a further object and feature of the present invention to provide such a system that permits convenient pouring of the collected fluids.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a fluid capture system, for use with an aircraft that discharges fluids in the vicinity of a landing wheel, comprising in combination: fluid retaining means for retaining the fluids discharged from the aircraft; wherein such fluid retaining means comprises: fluid damming means for containing the fluids within such fluid retaining means; and contour means for permitting placement of such fluid retaining means in a position substantially below a typical dripping area of the aircraft adjacent the landing wheel of the aircraft; wherein such contour means permits the landing wheel to remain outside such fluid damming means while in the position substantially below a typical dripping area of the aircraft; and wherein the landing wheel is partially surrounded by such fluid damming means. Moreover, it provides such a system wherein such fluid retaining means further comprises movement restricting means for restricting the movement of such fluid capture means by utilizing the weight of the aircraft. Additionally, it provides such a system further comprising stiffening means for stiffening such fluid retaining means against deflection. Also, it provides such a system wherein such fluid retaining means comprises indicia means for conveying information to a user of such system. In addition, it provides such a system wherein such fluid damming means comprises pour-assisting means for assisting in pouring and removal of the fluids collected within such fluid retaining means.

A fluid capture system for use with an aircraft that discharges fluids in the vicinity of a landing wheel comprising in combination: at least one fluid retainer structured and arranged to retain the fluids discharged from the aircraft; wherein such at least one fluid retainer comprises: at least one fluid dam structured and arranged to contain the fluids within such at least one fluid retainer; and at least one contour structured and arranged to permit placement of such at least one fluid retainer in a position substantially below a typical dripping area of the aircraft adjacent the landing wheel of the aircraft; wherein such at least one contour permits the landing wheel to remain outside such at least one fluid dam while in the position substantially below a typical dripping area of the aircraft; and wherein the landing wheel is partially surrounded by such at least one fluid dam. And it provides such a system further comprising: at least one movement restrictor structured and arranged to restrict movement of such system by utilizing the weight of the aircraft; wherein such at least one movement restrictor is structured and arranged to permit the landing wheel of the aircraft to be moved over at least one portion of such fluid capture system. Additionally, it provides such a system wherein such at least one movement restrictor is integrally molded with such at least one fluid retainer. Further, it provides such a system further comprising at least one stiffener structured and arranged to stiffen such at least one fluid retainer against deflection. Even further, it provides such a system wherein such at least one fluid retainer comprises indicia structured and arranged to convey information to a user. Additionally, it provides such a system wherein such at least one fluid dam comprises at least one pour assister structured and arranged to assist in pouring and removal of the fluids collected within such at least one fluid retainer. Additionally, it provides such a system wherein: such at least one fluid retainer comprises at least one substantially planar member having at least one top surface and at least one bottom surface and at least one peripheral edge; such at least one fluid dam extends vertically from such at least one top surface; and such at least one fluid dam is integrally molded along such at least one perimeter edge. Even further, it provides such a system wherein: such at least one substantially planar member comprises such at least one stiffener; and such at least one stiffener is integrally molded within such at least one top surface. Additionally, it provides such a system wherein: such at least one contour comprises at least one peripheral cutout of such one fluid retainer; and such at least one peripheral cutout permits such at least one fluid dam to surround the landing wheel on at least two sides. Even further, it provides such a system wherein such fluid capture system comprises a fluid impermeable plastic.

### BRIEF DESCRIPTION OF THE DRAWINGS

FIG. 1 is a perspective view of a drip pan system positioned around the front wheel area of an aircraft according to a preferred embodiment of the present invention.

FIG. 2 is an isometric view of the drip pan system showing the wheel cutout, perimeter rim and stiffener ribs according the preferred embodiment of the present invention.

FIG. 3 is a top view of the top of drip pan system according to the preferred embodiment of FIG. 2.

FIG. 4 is a front view of the drip pan system according to the preferred embodiment of FIG. 2.

FIG. 5 is a top view of the drip pan system showing the wheel insert, perimeter rim and stiffener ribs and further showing the web in the insert area upon which the aircraft wheel rests, to secure the pan from blowing away or being stolen according to another preferred embodiment of the present invention.

FIG. 6 is a front view of the drip pan system according to the preferred embodiment of FIG. 5.

FIG. 7 is an isometric view of the top of the drip pan system according to the preferred embodiment of FIG. 5.

FIG. 8 is a partial isometric view of a corner pouring spout configuration according to yet another preferred embodiment of the present invention.

FIG. 9 is a perspective view of the drip pan system positioned around an aircraft wheel according to the preferred embodiment of FIG. 2.

FIG. 10 is a perspective view of the drip pan system with the web of the drip pan system secured by the aircraft wheel.

### DETAILED DESCRIPTION OF A PREFERRED EMBODIMENT OF THE INVENTION

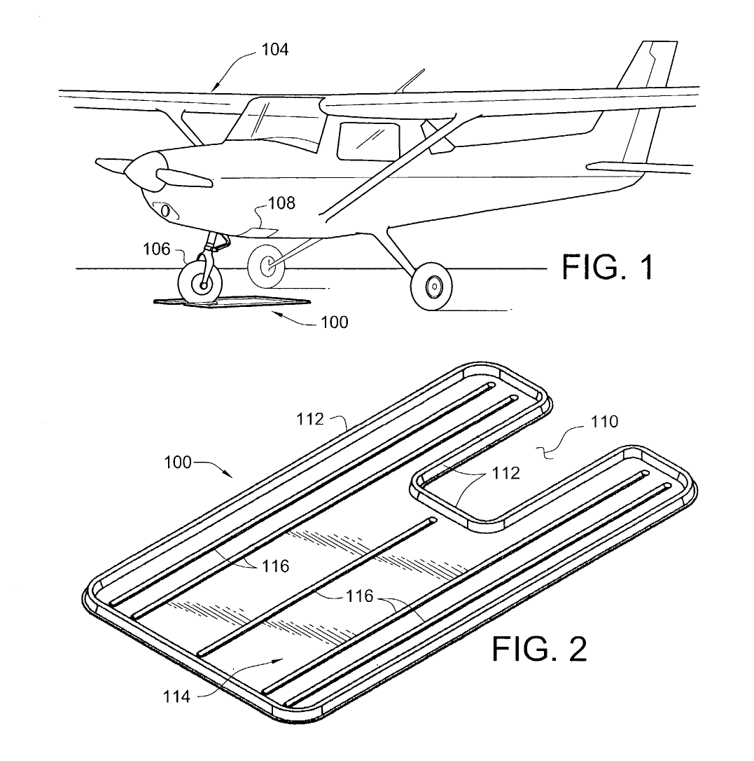

Reference is now made to the drawings. FIG. 1 is a perspective view of drip pan system 100 positioned around the front wheel area 102 of aircraft 104 according to a preferred embodiment of the present invention. Because the engine compartments of light aircraft are typically located above the nose wheel 106 of single engine aircraft (as shown) and commonly adjacent the main landing gear wheels of twin-engine aircraft, conventional drip pans intended for use by automobiles cannot be used, not having an accommodation for the wheel. Preferably, drip pan system 100 is adapted to permit effective positioning under the engine compartment 108 of aircraft 104 by incorporating peripheral wheel cutout 110, as shown.

FIG. 2 is an isometric view of the drip pan system showing peripheral wheel cutout 110, perimeter rim 112, fluid containment area 114 and stiffener ribs 116 according the preferred embodiment of the present invention. Although drip pan system 100 may be formed from stamped sheet metal or injected-molded plastic, in the preferred embodiment the pan is pressure or vacuum formed from sheet plastic, preferably, high-density polyethylene.

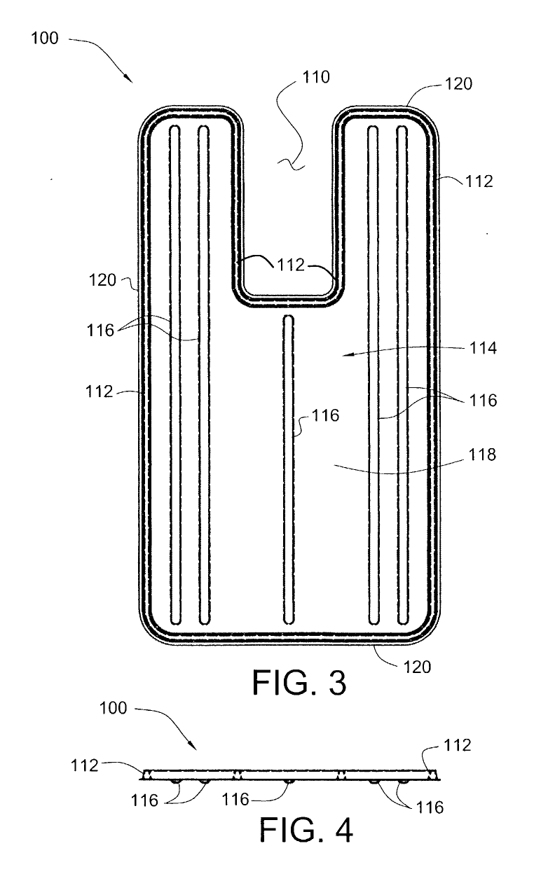

FIG. 3 is a top view of the top of drip pan system 100 according to the preferred embodiment of FIG. 2. Preferably, fluid containment area 114 comprises an essentially rectangular, planar panel 118 having a perimeter edge 120, as shown. Preferably, perimeter rim 112 extends continuously along perimeter edge 120 to form a dam-like structure surrounding fluid containment area 114, as shown. Peripheral cutout 110 comprises an essentially rectangular shaped indentation, preferably of a size to accommodate all aircraft wheels common to light aircraft, and is preferably formed within the narrow end of drip pan system 100, as shown. Although drip pan system 100 may conform to any desired size or capacity, drip pan system 100 has a preferred width of about 25″ and a preferred length of about 45″, as shown. Preferably, peripheral cutout 110 has a clear inside width of about 7½″ and a clear inside length of about 18″, as shown. Preferably, perimeter rim 112 has a height of about ⅝″.

A plurality of stiffener ribs 116 are preferably molded into the surface of planar panel 118 to add strength to drip pan system 100 by reducing deflection within planar panel 118 under load.

FIG. 4 is a front view of the drip pan system 100 according to the preferred embodiment of FIG. 2. Perimeter rim 112 preferably comprises an integrally molded element having an inverted “U”-shaped sectional profile as indicated within FIG. 4 by dashed lines. Preferably, perimeter rim 112 is of a height suitable to form a reservoir of a capacity to hold any predictable volume of fluid accumulations.

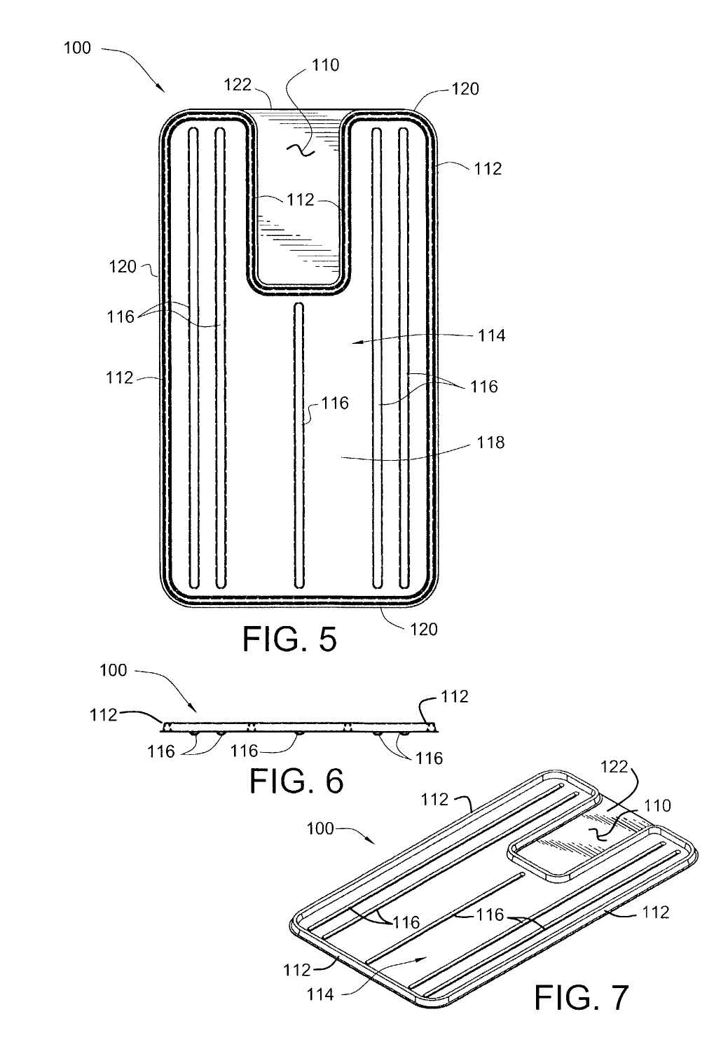

FIG. 5 is a top view of the drip pan system 100 showing peripheral wheel cutout 110, perimeter rim 112, fluid containment area 114, stiffener ribs 116 and further showing web 122 within peripheral wheel cutout 110 upon which the aircraft wheel rests, to secure drip pan system 100 from blowing away or being stolen according to another preferred embodiment of the present invention.

FIG. 6 is a front view of the drip pan system 100 according to the preferred embodiment of FIG. 5.

FIG. 7 is an isometric view of the top of the drip pan system 100, showing web 122 within peripheral wheel cutout 110, according to the preferred embodiment of FIG. 5.

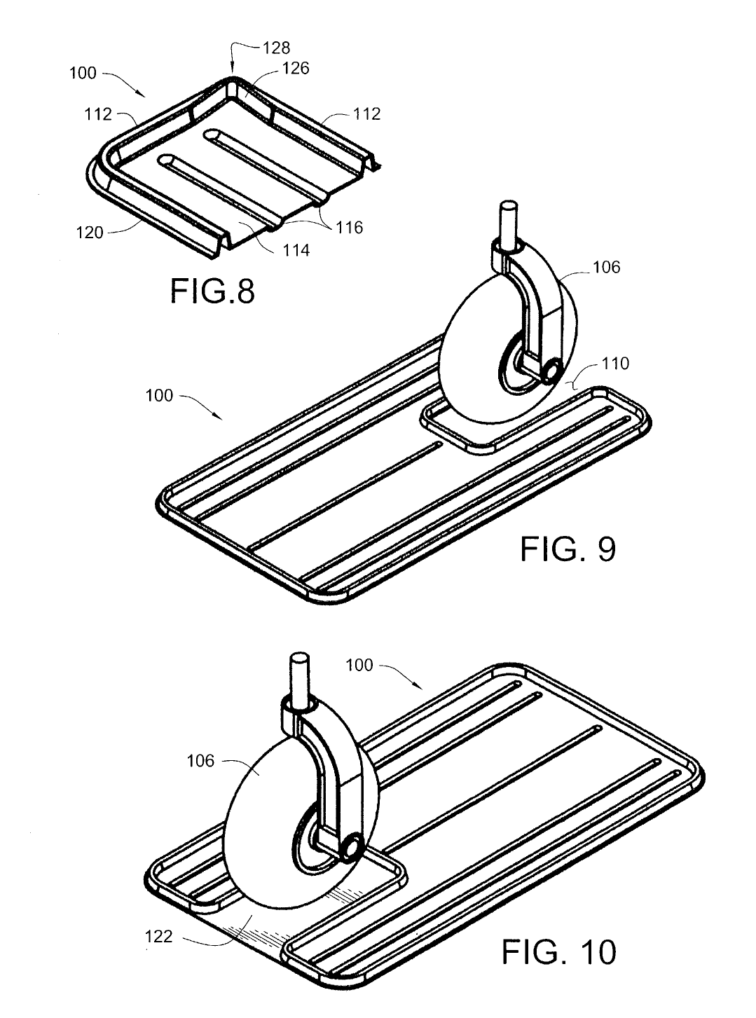

FIG. 8 is a partial isometric view of drip pan system 100 illustrating formed spout 126 according to yet another preferred embodiment of the present invention. Under appropriate circumstances, it may preferable to have in one or more corner(s) 128 of fluid containment area 114, formed spout 126 integrally molded within perimeter rim 112 to facilitate pouring accumulated fluids into a container for removal without spilling, as shown. Preferably, formed spout 126 comprises a narrowing of the inverted “U”-shaped profile of perimeter rim 112, as shown.

FIG. 9 is a perspective view of drip pan system 100 positioned around an aircraft wheel 106 according to the preferred embodiment of FIG. 2. Although drip pan system 100 may be use inside or outside an enclosed hanger, the embodiment of FIG. 9 is preferably used indoors where the potential of loss due to wind or theft is negligible.

FIG. 10 is a perspective view of drip pan system 100 with web 122 of drip pan system 100 secured by the weight of aircraft wheel 106, as shown. The embodiment of FIG. 10 is preferably used exterior of an enclosed hanger where the potential of loss due to wind or theft is greater.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A fluid capture system, for use with an aircraft that discharges fluids in the vicinity of a landing wheel, comprising in combination:
a) fluid retaining means for retaining the fluids discharged from the aircraft;
b) wherein said fluid retaining means comprises:
i) fluid damming means for containing the fluids within said fluid retaining means; and
ii) contour means for permitting placement of said fluid retaining means in a position substantially below a typical dripping area of the aircraft adjacent the landing wheel of the aircraft;
c) wherein said contour means permits the landing wheel to remain outside said fluid damming means while in the position substantially below a typical dripping area of the aircraft; and
d) wherein the landing wheel is partially surrounded by said fluid damming means.

2) The system according to claim 1 wherein said fluid retaining means further comprises movement restricting means for restricting the movement of said fluid capture means by utilizing the weight of the aircraft.

3) The system according to claim 1 further comprising stiffening means for stiffening said fluid retaining means against deflection.

4) The system according to claim 1 wherein said fluid retaining means comprises indicia means for conveying information to a user of said system.

5) The system according to claim 1 wherein said fluid damming means comprises pour-assisting means for assisting in pouring and removal of the fluids collected within said fluid retaining means.

6) A fluid capture system for use with an aircraft that discharges fluids in the vicinity of a landing wheel comprising in combination:
a) at least one fluid retainer structured and arranged to retain the fluids discharged from the aircraft;
b) wherein said at least one fluid retainer comprises:
i) at least one fluid dam structured and arranged to contain the fluids within said at least one fluid retainer; and
ii) at least one contour structured and arranged to permit placement of said at least one fluid retainer in a position substantially below a typical dripping area of the aircraft adjacent the landing wheel of the aircraft;
c) wherein said at least one contour permits the landing wheel to remain outside said at least one fluid dam while in the position substantially below a typical dripping area of the aircraft; and
d) wherein the landing wheel is partially surrounded by said at least one fluid dam.

7) The system according to claim 6 further comprising:
a) at least one movement restrictor structured and arranged to restrict movement of said system by utilizing the weight of the aircraft;
b) wherein said at least one movement restrictor is structured and arranged to permit the landing wheel of the aircraft to be moved over at least one portion of said fluid capture system.

8) The system according to claim 7 wherein said at least one movement restrictor is integrally molded with said at least one fluid retainer.

9) The system according to claim 6 further comprising at least one stiffener structured and arranged to stiffen said at least one fluid retainer against deflection.

10) The system according to claim 6 wherein said at least one fluid retainer comprises indicia structured and arranged to convey information to a user.

11) The system according to claim 6 wherein said at least one fluid dam comprises at least one pour assister structured and arranged to assist in pouring and removal of the fluids collected within said at least one fluid retainer.

12) The system according to claim 9 wherein:
a) said at least one fluid retainer comprises at least one substantially planar member having at least one top surface and at least one bottom surface and at least one peripheral edge;
b) said at least one fluid dam extends vertically from said at least one top surface; and
c) said at least one fluid dam is integrally molded along said at least one perimeter edge.

13) The system according to claim 12 wherein:
a) said at least one substantially planar member comprises said at least one stiffener; and
b) said at least one stiffener is integrally molded within said at least one top surface.

14) The system according to claim 13 wherein:
a) said at least one contour comprises at least one peripheral cutout of said one fluid retainer; and
b) said at least one peripheral cutout permits said at least one fluid dam to surround the landing wheel on at least two sides.

15) The system according to claim 14 wherein said fluid capture system comprises a fluid impermeable plastic.

16) Each and every novel feature, element, combination, step and/or method disclosed or suggested by this patent application.
